(19) United States
(12) Patent Application Publication
(10) Pub. No.: US 2024/0073038 A1
(43) Pub. Date: Feb. 29, 2024

(54) CERTIFICATE REQUESTING METHOD, CERTIFICATE ISSUING METHOD, CERTIFICATE SYSTEM AND COMPUTER-READABLE MEDIUM THEREOF

(71) Applicant: CHT SECURITY CO., LTD., Taipei City (TW)

(72) Inventors: Wen-Cheng WANG, Taipei City (TW); Yao-Kuan HUANG, Taipei City (TW); Wan-Ju YANG, Taipei City (TW)

(21) Appl. No.: 18/239,862

(22) Filed: Aug. 30, 2023

(30) Foreign Application Priority Data
Aug. 31, 2022 (TW) 111132959

(51) Int. Cl. H04L 9/32; H04L 9/30

(52) U.S. Cl. CPC H04L 9/3268; H04L 9/3073

(57) ABSTRACT

A certificate requesting method, a certificate issuing method, a certificate system and a computer-readable medium thereof are provided, in which subscriber identity identification information, a private key and a public key certificate bound to a first security chip are converted into a private key bound to a second security chip via an online identity authentication procedure, and the corresponding public key certificate is issued by a certificate authority server, so as to improve the usability, the convenience and the security thereof.

### BACKGROUND

### 1. Technical Field

The present disclosure relates to request and issuance of certificates, and more particularly, to a transformation of a binding relationship between a private key, a public key certificate and a security chip.

### 2. Description of Related Art

In end-to-end encryption (E2EE) for Voice over Internet protocol (Voice over IP, VoIP) communications, the subscriber will obtain a subscriber identity module (SIM) issued by the communications system in advance, and the subscriber identity module already contains the subscriber's key pair, including a private key and a public key.

After the subscriber logs into the communications system via the VoIP application program in the mobile phone, the subscriber can call other subscribers. When the called subscriber agrees to answer, after completing the handshake protocol of the call, the VoIP application programs of both parties will use the private key and public key in their respective subscriber identity modules for key exchange, so as to generate a common session key for both parties via the key exchange process. Then, the voice data packets of the conversation between the two parties will be encrypted with the session key, and then sent to the other party via the secure real-time transport protocol (Secure RTP). Each call will use the subscriber identity modules of both parties to randomly exchange and generate a common session key in a secure manner, thereby ensuring that eavesdroppers cannot obtain the subscriber's private key and the session key of the conversation, and only the two parties in the call can decrypt and listen to the other party's conversation.

However, at present, the operating systems of some mobile phones cannot directly access the subscriber identity module. For example, Apple's iOS operating system does not provide an application program interface (API) that can transmit instructions to the subscriber identity module. If such a mobile phone is to be used for E2EE VoIP, the aforementioned technical solution is not applicable, resulting in insufficient usability, convenience and security.

### SUMMARY

In order to solve the above problems, the present disclosure provides a certificate requesting method executed by a mobile device, the mobile device comprising a built-in security chip and an external security chip, and the certificate requesting method comprising: generating a pair of a built-in public key and a built-in private key in the built-in security chip; generating a certificate signing request according to the built-in private key, wherein the certificate signing request includes subscriber identity identification information and the built-in public key; sending the certificate signing request to a certificate authority server to receive a confirmation code sent by the certificate authority server; signing the confirmation code with an external private key in the external security chip, and then sending the confirmation code to the certificate authority server; and downloading a public key certificate from the certificate authority server, wherein the public key certificate includes the subscriber identity identification information and the built-in public key.

The present disclosure further provides a certificate issuing method executed by a certificate authority server, and the certificate issuing method comprising: receiving a certificate signing request sent by a mobile device, wherein the certificate signing request includes subscriber identity identification information and a built-in public key in a built-in security chip of the mobile device; generating a confirmation code according to the certificate signing request to send the confirmation code to the mobile device; and receiving the confirmation code signed by an external private key in an external security chip of the mobile device, and then using an external public key corresponding to the external private key to verify the confirmation code, wherein a public key certificate is issued when the verification of the confirmation code is successful, and then the public key certificate is sent to the mobile device, and wherein the public key certificate includes the subscriber identity identification information and the built-in public key.

The present disclosure further provides a certificate system comprising a mobile device and a certificate authority server that are communicatively connected to each other, wherein the mobile device includes a built-in security chip and an external security chip to perform: generating a pair of a built-in public key and a built-in private key in the built-in security chip; generating a certificate signing request according to the built-in private key, wherein the certificate signing request includes subscriber identity identification information and the built-in public key; sending the certificate signing request to the certificate authority server to receive a confirmation code sent by the certificate authority server; signing the confirmation code with an external private key in the external security chip, and then sending the confirmation code to the certificate authority server; and downloading a public key certificate from the certificate authority server, wherein the public key certificate includes the subscriber identity identification information and the built-in public key, and the certificate authority server executes: receiving the certificate signing request sent by the mobile device; generating the confirmation code according to the certificate signing request, so as to send the confirmation code to the mobile device; and receiving the confirmation code signed by the external private key of the mobile device, and verifying the confirmation code with an external public key corresponding to the external private key, wherein the public key certificate is issued when the verification of the confirmation code is successful, and then the public key certificate is sent to the mobile device.

The present disclosure further provides a computer-readable medium applied to a mobile device or a server and storing instructions to execute the above-mentioned certificate requesting method or the above-mentioned certificate issuing method.

The present disclosure associates the subscriber identity of the built-in security chip with the subscriber identity of the external security chip via the signing and verification of the above-mentioned confirmation code, so as to convert the binding relationship between the subscriber and the key pair of the external security chip into the binding relationship between the subscriber and the key pair of the built-in security chip, so as to increase the usability, the convenience and the security thereof.

### BRIEF DESCRIPTION OF THE DRAWINGS

FIG. 1 is a flowchart illustrating a certificate requesting method and a certificate issuing method according to an embodiment of the present disclosure.

FIG. 2 is a schematic view of an application environment of a certificate requesting method and a certificate issuing method and a certificate system thereof according to an embodiment of the present disclosure.

FIG. 3 is a schematic view of an external security chip and a carrier thereof according to an embodiment of the present disclosure.

FIG. 4 is a schematic view of an external security chip and a carrier thereof according to another embodiment of the present disclosure.

### DETAILED DESCRIPTIONS

The following describes the implementation of the present disclosure with examples. Those skilled in the art can easily understand other advantages and effects of the present disclosure from the contents disclosed in this specification.

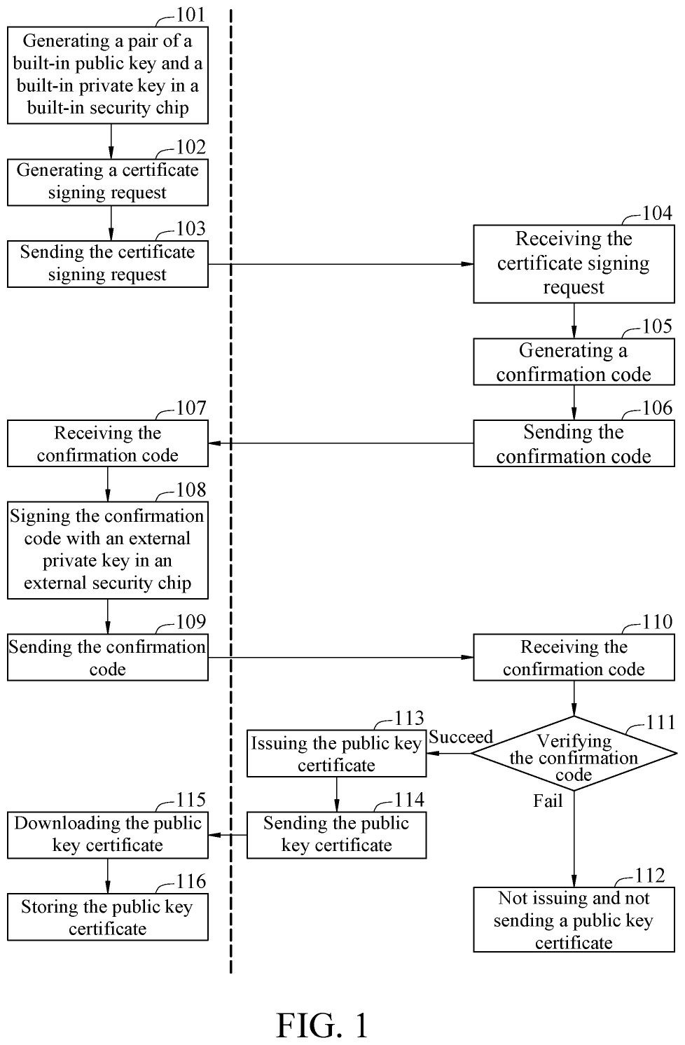

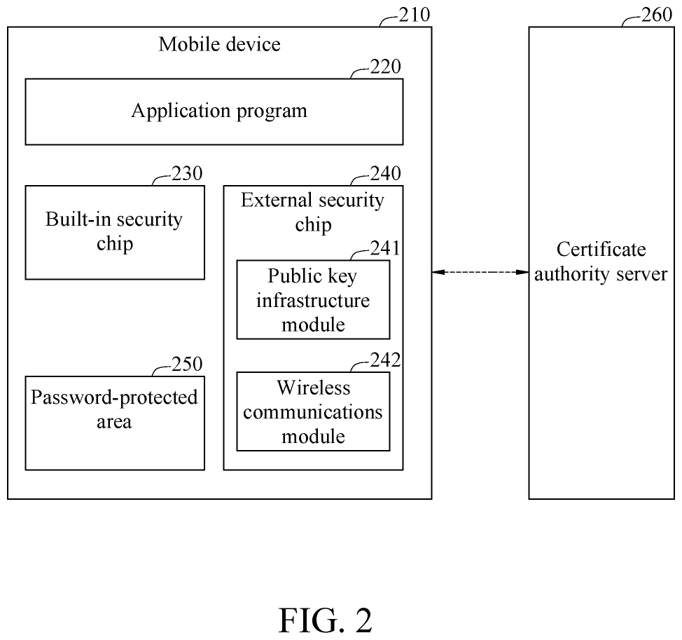

Please refer to FIG. 1 and FIG. 2. FIG. 1 is a flowchart illustrating a certificate requesting method and a certificate issuing method according to an embodiment of the present disclosure. Bounded by a vertical dotted line in FIG. 1, the steps on the left side of the dotted line belong to a certificate requesting method executed by a mobile device 210 in FIG. 2, and the steps on the right side of the dotted line belong to a certificate issuing method executed by a certificate authority (CA) server 260 in FIG. 2.

In one embodiment, the mobile device 210 includes an application program 220, a built-in security chip 230, an external security chip 240 and a password-protected area 250. The external security chip 240 includes a public key infrastructure (PKI) module 241 and a wireless communications module 242. The mobile device 210 can be a smart phone or a tablet computer. The built-in security chip 230 is built into the hardware framework of the mobile device 210. The external security chip 240 can be made into a subscriber identity module (SIM) and installed in the mobile device 210. In one embodiment, the public key infrastructure (PKI) module is implemented with a PKI program. In other embodiments, the above modules can be software, hardware, or firmware. If the above modules are hardware, they can be processing units, processors, computers, or servers with data processing and computing capabilities. If the above modules are software or firmware, they may include instructions executable by a processing unit, a processor, a computer, or a server, and may be installed on the same hardware device or distributed across a plurality of different hardware devices.

In an embodiment, the external security chip 240 includes a key pair that can be used for E2EE VoIP communications. However, since the operating system of the mobile device 210 cannot directly access the external security chip 240, it is necessary to execute the certificate requesting method and the certificate issuing method shown in FIG. 1 to convert subscriber identity identification information, private key and public key certificate that have been bound on the external security chip 240 into a private key bound on the built-in security chip 230, and a corresponding public key certificate is issued by the certificate authority server 260. Afterward, the built-in security chip 230 can be used as a secure element required for VoIP E2EE communications to protect the private key of the built-in security chip 230, perform key exchange to generate a session key, and protect the session key for VoIP E2EE communications.

Before executing the method flow in FIG. 1, the subscriber needs to apply to the communications system to obtain the external security chip 240 issued by the communications system. The external security chip 240 issued by the communications system already contains the subscriber's key pair, including a private key and a public key (hereinafter respectively referred to as the external private key and the external public key), wherein the external private key is protected by the external security chip 240 and cannot be exported from the external security chip 240, while the external public key can be exported from the external security chip 240.

The subscriber can attach the external security chip 240 to the original standard subscriber identity module of the mobile device 210, and then place the external security chip 240 and the standard subscriber identity module that are attached together into the mobile device 210. Afterward, the mobile device 210 can send instructions related to encryption, decryption and key to the external security chip 240 for calculation via a pin interface (not shown) of a subscriber identity module slot, and the external security chip 240 will forward a subscriber identity module instruction related to the original mobile communications to the original standard subscriber identity module, and then return the processing result of the instruction to the mobile device 210, so the original mobile communications function will not be affected.

The flow of the method shown in FIG. 1 is described below.

First, in step 101, the subscriber operates the application program 220 of the mobile device 210 to generate a key pair in the built-in security chip 230, that is, a pair of public key and private key (hereinafter referred to as the built-in public key and the built-in private key, respectively), wherein the built-in private key is protected by the built-in security chip 230 and cannot be exported from the built-in security chip 230, while the built-in public key can be exported from the built-in security chip 230.

In step 102, the application program 220 generates a certificate signing request (CSR) according to the built-in private key. The certificate signing request may include subscriber identity identification information (such as subscriber name or subscriber identification number) of the subscriber of the mobile device 210 and a built-in public key, and the certificate signing request has been signed by the built-in private key.

In step 103, the application program 220 sends the certificate signing request to the certificate authority server 260.

In step 104, the certificate authority server 260 receives the certificate signing request sent by the application program 220.

In step 105, the certificate authority server 260 generates a confirmation code according to the certificate signing request. The confirmation code is generated according to the certificate signing request and a random number, and there is a one-to-one correspondence between the confirmation code and the certificate signing request.

In step 106, the certificate authority server 260 sends the confirmation code to the mobile device 210.

In step 107, the application program 220 receives the confirmation code sent by the certificate authority server 260.

In step 108, the mobile device 210 signs the confirmation code with the external private key in the external security chip 240.

Then, in step 109, the signed confirmation code is sent to the certificate authority server 260.

In one embodiment, the operating system of the mobile device 210 does not provide any application program interface for transmitting instructions to the external security chip 240, so the application program 220 cannot directly access the external security chip 240. In order to complete step 108 and step 109, the subscriber can operate a function menu provided by the external security chip 240, so that the public key infrastructure module 241 signs the confirmation code with an external private key, and thus the wireless communications module 242 transmits the signed confirmation code to the certificate authority server 260. For instance, if the mobile device 210 is an iPhone of Apple Inc., then the wireless communications module 242 can use a SIM application toolkit (STK) of the external security chip 240 to send the signed confirmation code to the certificate authority server 260 via a way of bearer independent protocol (BIP) and a connection method of hypertext transfer protocol (HTTP).

Next, in step 110, the certificate authority server 260 receives the confirmation code signed by the external private key of the mobile device 210.

In step 111, the certificate authority server 260 verifies the confirmation code with the external public key corresponding to the external private key. The certificate authority server 260 can store external public keys of multiple subscribers, and according to the subscriber identity identification information in the certificate signing request received in step 104, obtain the external public key corresponding to the external private key of the external security chip 240 from the plurality of external public keys of the above-mentioned multiple subscribers to verify the confirmation code. The verification of the confirmation code includes verifying the digital signature of the confirmation code and checking whether the confirmation code is correct.

If the verification in step 111 fails, then the process goes to step 112, and the certificate authority server 260 does not issue any public key certificate, and does not send any public key certificate to the mobile device 210. If the verification in step 111 is successful, it means that the subscriber of the mobile device 210 is the subscriber who is bound to the external security chip 240, and then the process goes to step 113.

In step 113, the certificate authority server 260 issues a public key certificate. The public key certificate is generated according to the certificate signing request received in step 104. Therefore, the public key certificate includes the subscriber identity identification information and the built-in public key in the certificate signing request, and also includes information such as valid date.

In step 114, the certificate authority server 260 transmits the public key certificate to the mobile device 210.

In step 115, the application program 220 of the mobile device 210 downloads the public key certificate from the certificate authority server 260.

In one embodiment, before sending the public key certificate in step 114, the certificate authority server 260 may push a notification message to the application program 220 that the public key certificate has been issued and can be downloaded. After the subscriber sees the notification message, the application program 220 can be operated to start downloading the public key certificate, then the certificate authority server 260 executes step 114, and the application program 220 executes step 115.

After the downloading in step 115 is completed, in step 116, the application program 220 stores the public key certificate in the password-protected area 250 of the operating system of the mobile device 210. For example, if the mobile device 210 is an iPhone of Apple Inc., then the password-protected area 250 is a keychain password management system of iOS.

After completing the method shown in FIG. 1, the subscriber identity corresponding to the external private key of the external security chip 240 has been bound with the built-in private key, the built-in public key and the public key certificate of the built-in security chip 230. Therefore, the application program 220 can use the built-in security chip 230 and the password-protected area 250 in the mobile device 210 as secure elements, and use the built-in private key in the built-in security chip 230 and the public key certificate in the password-protected area 250 to perform identity authentication and key exchange, so as to perform E2EE VoIP communications with another subscriber's mobile device.

The present disclosure is not limited to making the external security chip 240 as a subscriber identity module. For example, in one embodiment, the mobile device 210 itself and the wireless communications module 242 in the external security chip 240 can support the same short-range wireless communications protocol, such as Bluetooth or near-field communications (NFC) protocol. In this way, the application program 220 can send an instruction via the wireless communications protocol in step 108, so that the public key infrastructure module 241 signs the confirmation code with the external private key. Then, in step 109, the confirmation code signed by the external private key is sent to the certificate authority server 260.

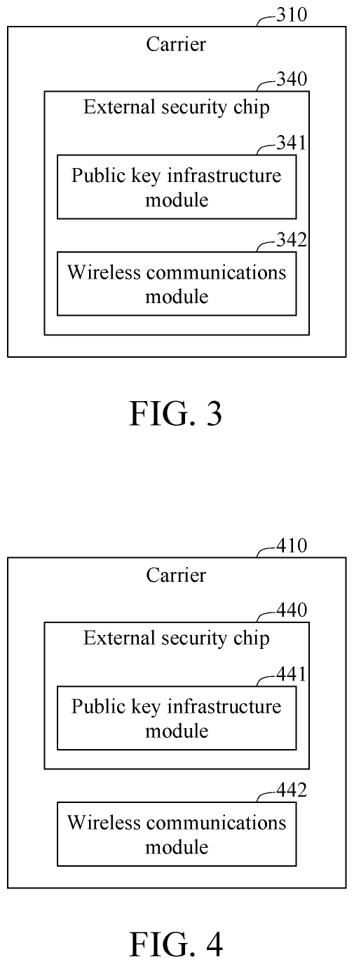

FIG. 3 is a schematic view of an external security chip 340 and a carrier 310 thereof according to another embodiment of the present disclosure.

The external security chip 340 is disposed in the carrier 310 and includes a public key infrastructure module 341 and a wireless communications module 342 that are communicatively connected to each other. The mobile device 210 of this embodiment does not include the external security chip 240, and the carrier 310 is an independent component outside the mobile device 210. The mobile device 210 itself and the wireless communications module 342 in the external security chip 340 support the same short-range wireless communications protocol, such as Bluetooth or NFC protocol. In this way, the application program 220 can send an instruction via the wireless communications protocol in step 108, so that the public key infrastructure module 341 can sign the confirmation code with the external private key. Then, in step 109, the confirmation code signed by the external private key is sent to the certificate authority server 260. In addition, other technical details of this embodiment are the same as the embodiment shown in FIG. 2.

FIG. 4 is a schematic view of an external security chip 440 and a carrier 410 thereof according to yet another embodiment of the present disclosure.

The external security chip 440 is disposed in the carrier 410 and includes a public key infrastructure module 441, and the carrier 410 includes a wireless communications module 442. The public key infrastructure module 441 and the wireless communications module 442 are communicatively connected to each other. The mobile device 210 of this embodiment does not include the external security chip 240, and the carrier 410 is an independent component outside the mobile device 210. The mobile device 210 itself and the wireless communications module 442 in the carrier 410 support the same short-range wireless communications protocol, such as Bluetooth or NFC protocol. In this way, the application program 220 can send an instruction via the wireless communications protocol in step 108, so that the public key infrastructure module 441 signs the confirmation code with the external private key. Then, in step 109, the confirmation code signed by the external private key is sent to the certificate authority server 260. In addition, other technical details of this embodiment are the same as the embodiment shown in FIG. 2.

In one embodiment, the present disclosure further provides a computer-readable medium, such as a memory, a floppy disk, a hard disk, or an optical disk. The computer-readable medium is applied to a mobile device or a server, and stores instructions to execute the above certificate requesting method or the certificate issuing method.

The foregoing embodiments are provided for the purpose of illustrating the principles and effects of the present disclosure, rather than limiting the present disclosure. Anyone skilled in the art can modify and alter the above embodiments without departing from the spirit and scope of the present disclosure. Therefore, the scope of protection with regard to the present disclosure should be as defined in the accompanying claims listed below.

What is claimed is:

1. A certificate requesting method executed by a mobile device, the mobile device comprising a built-in security chip and an external security chip, and the certificate requesting method comprising:
generating a pair of a built-in public key and a built-in private key in the built-in security chip;
generating a certificate signing request according to the built-in private key, wherein the certificate signing request includes subscriber identity identification information and the built-in public key;
sending the certificate signing request to a certificate authority server to receive a confirmation code sent by the certificate authority server;
signing the confirmation code with an external private key in the external security chip, and then sending the confirmation code to the certificate authority server; and
downloading a public key certificate from the certificate authority server, wherein the public key certificate includes the subscriber identity identification information and the built-in public key.

2. The certificate requesting method of claim 1, wherein the external security chip includes a public key infrastructure module and a wireless communications module, and the signing and sending of the confirmation code comprise:
enabling the public key infrastructure module to sign the confirmation code with the external private key; and
enabling the wireless communications module to send the confirmation code to the certificate authority server.

3. The certificate requesting method of claim 1, wherein the external security chip includes a public key infrastructure module, the external security chip supports a wireless communications protocol or is disposed in a carrier supporting the wireless communications protocol, and the signing of the confirmation code comprises:
sending an instruction via the wireless communications protocol, so that the public key infrastructure module uses the external private key to sign the confirmation code.

4. The certificate requesting method of claim 1, further comprising:
storing the public key certificate in a password-protected area of an operating system of the mobile device.

5. A certificate issuing method executed by a certificate authority server, and the certificate issuing method comprising:
receiving a certificate signing request sent by a mobile device, wherein the certificate signing request includes subscriber identity identification information and a built-in public key in a built-in security chip of the mobile device;
generating a confirmation code according to the certificate signing request to send the confirmation code to the mobile device; and
receiving the confirmation code signed by an external private key in an external security chip of the mobile device, and then using an external public key corresponding to the external private key to verify the confirmation code, wherein a public key certificate is issued when the verification of the confirmation code is successful, and then the public key certificate is sent to the mobile device, and wherein the public key certificate includes the subscriber identity identification information and the built-in public key.

6. The certificate issuing method of claim 5, wherein the confirmation code is generated according to the certificate signing request and a random number.

7. The certificate issuing method of claim 5, wherein the verification of the confirmation code comprises:
obtaining the external public key corresponding to the external private key from a plurality of public keys of a plurality of subscribers according to the subscriber identity identification information to verify the confirmation code.

8. The certificate issuing method of claim 5, further comprising:
not issuing and not sending the public key certificate if the verification of the confirmation code fails.

9. A certificate system comprising a mobile device and a certificate authority server that are communicatively connected to each other, wherein
the mobile device includes a built-in security chip and an external security chip to perform: generating a pair of a built-in public key and a built-in private key in the built-in security chip; generating a certificate signing request according to the built-in private key, wherein the certificate signing request includes subscriber identity identification information and the built-in public key; sending the certificate signing request to the certificate authority server to receive a confirmation code sent by the certificate authority server; signing the confirmation code with an external private key in the external security chip, and then sending the confirmation code to the certificate authority server; and downloading a public key certificate from the certificate authority server, wherein the public key certificate includes the subscriber identity identification information and the built-in public key; and
the certificate authority server executes: receiving the certificate signing request sent by the mobile device; generating the confirmation code according to the certificate signing request, so as to send the confirmation code to the mobile device; and receiving the confirmation code signed by the external private key of the mobile device, and verifying the confirmation code with an external public key corresponding to the external private key, wherein the public key certificate is issued when the verification of the confirmation code is successful, and then the public key certificate is sent to the mobile device.

10. The certificate system of claim 9, wherein the certificate signing request has been signed by the built-in private key before the mobile device sends the certificate signing request to the certificate authority server.

11. The certificate system of claim 9, wherein the external security chip includes a public key infrastructure module and a wireless communications module, and the signing and sending of the confirmation code by the mobile device comprise:
enabling the public key infrastructure module to sign the confirmation code with the external private key; and
enabling the wireless communications module to send the confirmation code to the certificate authority server.

12. The certificate system of claim 9, wherein the external security chip includes a public key infrastructure module, the external security chip supports a wireless communications protocol or is disposed in a carrier supporting the wireless communications protocol, and the signing of the confirmation code comprises:
sending an instruction via the wireless communications protocol, so that the public key infrastructure module uses the external private key to sign the confirmation code.

13. The certificate system of claim 9, wherein the mobile device further performs:
storing the public key certificate in a password-protected area of an operating system of the mobile device.

14. The certificate system of claim 9, wherein the confirmation code is generated according to the certificate signing request and a random number.

15. The certificate system of claim 9, wherein the verification of the confirmation code by the certificate authority server comprises:
obtaining the external public key corresponding to the external private key from a plurality of public keys of a plurality of subscribers according to the subscriber identity identification information to verify the confirmation code.

16. The certificate system of claim 9, wherein the certificate authority server further performs:
not issuing and not sending the public key certificate if the verification of the confirmation code fails.
